(19) United States
(12) Patent Application Publication
(10) Pub. No.: US 2025/0360762 A1
(43) Pub. Date: Nov. 27, 2025

(54) VEHICLE REAR BODY STRUCTURE OF VEHICLE INCLUDING TRAILER HITCH

(71) Applicant: SUBARU CORPORATION, Tokyo (JP)

(72) Inventor: Akihiro MAEDA, Tokyo (JP)

(21) Appl. No.: 19/071,089

(22) Filed: Mar. 5, 2025

(30) Foreign Application Priority Data
May 22, 2024 (JP) 2024-083648 A

(51) Int. Cl. B60D 1/24; B60D 1/06; B60K 1/00; B62D 21/05

(52) U.S. Cl. CPC B60D 1/244; B60D 1/065; B60K 1/00; B62D 21/05

(57) ABSTRACT

A vehicle rear body structure includes rear side frames extending along a front-rear direction, a trailer hitch fixedly provided in the rear side frames, a subframe between the rear side frames, a high voltage component on the subframe, and mounts supporting the high voltage component. The trailer hitch includes brackets fixed to the rear side frames respectively and having a length shorter than a height from the rear side frames to the subframe, a cross member between the brackets, a stay extending downward from the cross member, an arm extending rearward from the stay, a support shaft erecting on the arm, and a hitch ball provided on the support shaft below the rear side frames. The mounts include front mounts and a rear mount. A rotational moment is generated on a downward side where the trailer hitch collides with the rear mount at a collision from behind.

### CROSS-REFERENCE TO RELATED APPLICATIONS

The present application claims priority from Japanese Patent Application No. 2024-083648 filed on May 22, 2024, the entire contents of which are hereby incorporated by reference.

### BACKGROUND

The disclosure relates to a vehicle rear body structure of a vehicle equipped with a trailer hitch and including a high voltage component as a drive source.

Some vehicles such as automobiles have a trailer hitch attached to a rear portion of a vehicle body. The trailer hitch is a tow apparatus that tows a camping trailer, a boat trailer that transports a small boat, and the like by a vehicle. For example, Japanese Unexamined Patent Application Publication No. 2015-189447 discloses a technique for absorbing a collision load when the collision load is input to a trailer hitch.

### SUMMARY

An aspect of the disclosure provides a vehicle rear body structure of a vehicle. The vehicle rear body structure of the vehicle includes a pair of rear side frames, a trailer hitch, a subframe, a high voltage component, and mounts. The pair of rear side frames extend along a front-rear direction in a rear part of a vehicle body. The trailer hitch is fixedly provided in the rear side frames. The subframe is provided between the rear side frames. The high voltage component is placed on the subframe and configured to drive a rear wheel of the vehicle. The mounts support the high voltage component on the subframe. The trailer hitch includes a pair of brackets, a cross member, a stay, an arm, a support shaft, and a hitch ball. The pair of brackets are fixed to the rear side frames respectively and have a length in the front-rear direction set to be shorter than a height in an up-down direction of the vehicle body from a lower end of the rear side frames to a lower end of the subframe. The cross member is provided between the pair of brackets. The stay projects from a center in a vehicle width direction of the cross member and extends downward. The arm projects from a bottom portion of the stay and extends rearward. The support shaft erects on a rear end portion of the arm. The hitch ball is provided on an upper portion of the support shaft and provided below the pair of rear side frames. The mounts include a pair of front mounts and a rear mount. The pair of front mounts support two side portions on a front side of the high voltage component. The rear mount supports a rear portion of the high voltage component at the center in the vehicle width direction. The vehicle rear body structure of the vehicle is configured such that a rotational moment is generated on a downward side where the trailer hitch being given a collision load from a collision body collides with the rear mount at a collision from behind.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a top view illustrating a vehicle including a trailer hitch;

FIG. 2 is a side view illustrating the vehicle including the trailer hitch;

FIG. 3 is a plan view of the trailer hitch, rear side frames, a motor, and a subframe provided in a vehicle rear body as viewed from above the vehicle;

FIG. 4 is a bottom view of the trailer hitch, the rear side frames, the motor, and the subframe provided in the vehicle rear body as viewed from below the vehicle;

FIG. 5 is a side view of the trailer hitch, the rear side frames, the motor, and the subframe provided in the vehicle rear body as viewed from the left side of the vehicle;

FIG. 6 is a perspective view illustrating the trailer hitch fastened and fixed to the rear side frames;

FIG. 7 is a plan view illustrating a vehicle rear body structure made up of the trailer hitch, the rear side frames, the motor, and the subframe;

FIG. 8 is a side view of the vehicle rear body structure made up of the trailer hitch, the rear side frames, the motor, and the subframe as viewed from the left side of the vehicle;

FIG. 9 is a side view of the vehicle rear body structure made up of the trailer hitch, the rear side frames, the motor, and the subframe as viewed from the left side of the vehicle when a collision body collides with the vehicle rear body structure from behind;

FIG. 10 is a side view of the vehicle rear body structure made up of the trailer hitch, the rear side frames, the motor, and the subframe as viewed from the left side of the vehicle, illustrating an initial stage when the collision body collides with the vehicle rear body structure from behind;

FIG. 11 is a side view of the vehicle rear body structure made up of the trailer hitch, the rear side frames, the motor, and the subframe as viewed from the left side of the vehicle, illustrating a middle stage when the collision body collides with the vehicle rear body structure from behind; and

FIG. 12 is a side view of the vehicle rear body structure made up of the trailer hitch, the rear side frames, the motor, and the subframe as viewed from the left side of the vehicle, illustrating a late stage when the collision body collides with the vehicle rear body structure from behind.

### DETAILED DESCRIPTION

Various electric (electric-powered) vehicles (EVs) such as a battery electric vehicle (BEV), a hybrid electric vehicle (HEV), a plug-in hybrid electric vehicle (PHEV), and a fuel cell electric vehicle (FCEV) use a high voltage component such as a motor as a drive source.

Therefore, the EV can generate a larger torque than a vehicle having an internal combustion engine (ICE). This allows the EV to generate a driving force comparable to the ICE even if the EV is smaller-bodied than the ICE.

Note that smaller-bodied vehicles often have a short rear overhang. Such small-bodied vehicles are practically unlikely to absorb collision energy with a frame at a collision from behind, and thus it has been difficult to equip a trailer hitch.

In other words, it is difficult for the small-bodied vehicles to secure a stroke desired for crush in terms of protection from a collision from behind. For example, when the small-bodied vehicle is a rear-wheel drive EV in which the high voltage component such as a motor is provided on the rear side, the impact absorbing capability of a frame is limited when a trailer hitch is equipped.

For this reason, there is a problem that it is difficult to absorb collision energy at a collision from behind and the high voltage component such as a motor is unlikely to be protected.

It is thus desirable to provide a vehicle rear body structure of a vehicle capable of absorbing adequate collision energy at a collision from behind in a small-bodied electric (electric-powered) vehicle including a trailer hitch.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

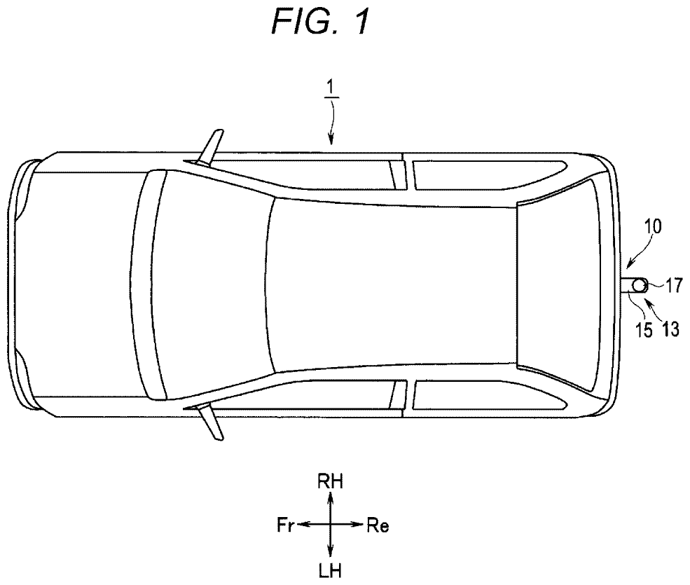

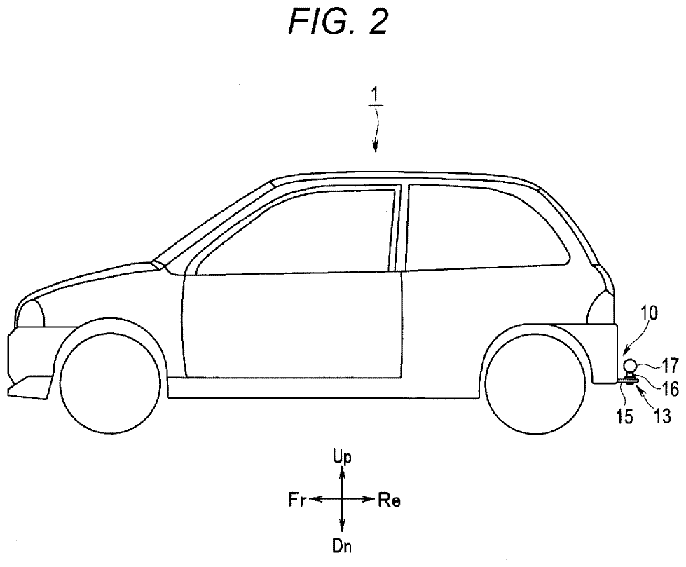

As illustrated in FIGS. 1 and 2, a vehicle 1 that is an electric vehicle according to the present embodiment includes a trailer hitch 10 that is a tow apparatus. Note that, in the following description, front, rear, left, and right directions of the trailer hitch correspond to the front, rear, left, and right of the vehicle 1 to which the trailer hitch 10 is connected. Therefore, in the drawings, Fr represents the front of the vehicle body, Re represents the rear of the vehicle body, LH represents the left side in a vehicle width direction, and RH represents the right side in the vehicle width direction.

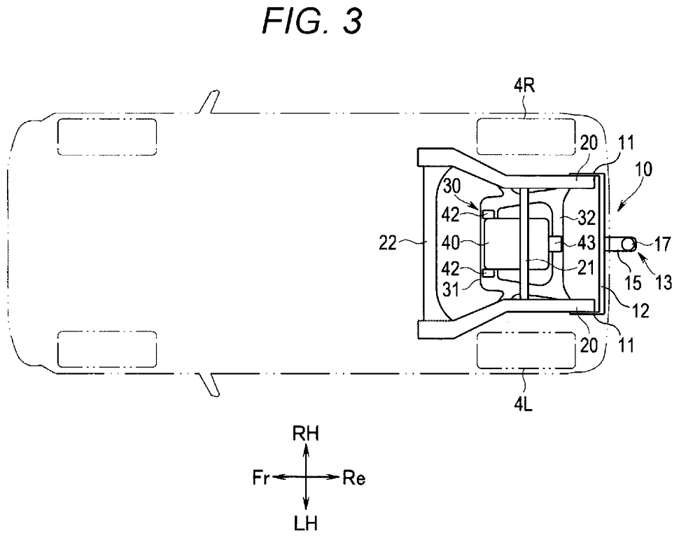

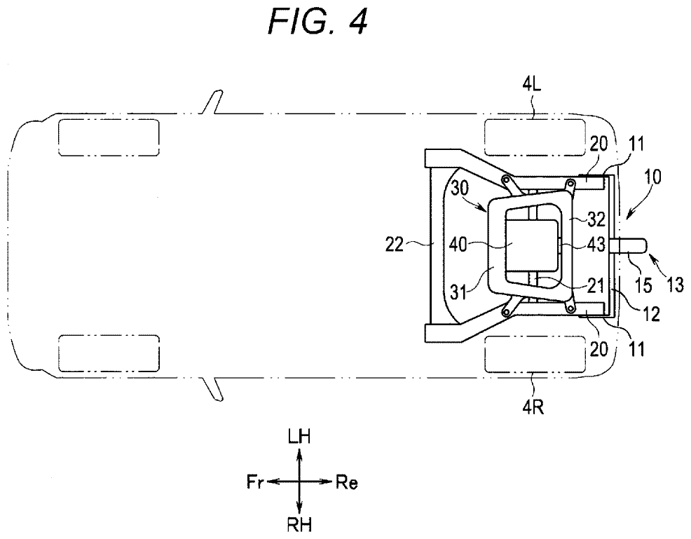

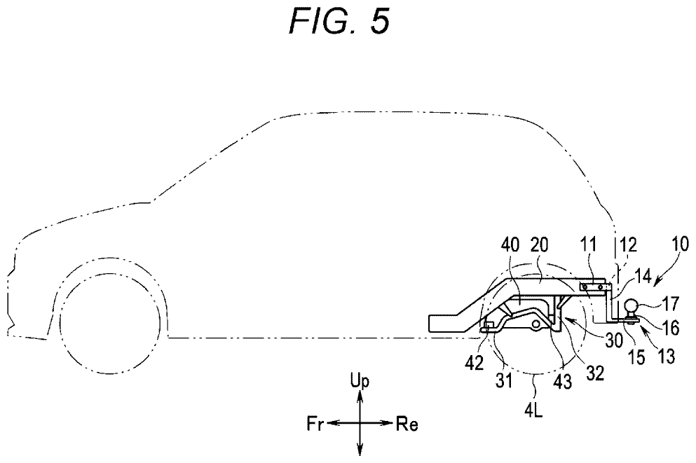

As illustrated in FIGS. 3 to 5, the trailer hitch 10 is fixedly provided in a pair of rear side frames 20 that are rear frames provided on the left and right in the vehicle width direction of a vehicle rear body. Each rear side frame 20 extends toward a rear side of the vehicle body at a rear end portion of a side sill (not illustrated).

A cross member 21 is connected to the rear side frames 20 between substantially central parts in a front-rear direction of the vehicle 1. Note that each rear side frame 20 is also connected to a cross member 22 on a front side of the vehicle body.

Two left and right ends of the cross member 22 are joined to facing surfaces of rear end portions of a pair of left and right side sills (not illustrated). Furthermore, front portions of the rear side frames 20 are joined to the cross member 22.

A suspension cross member 30 that is a subframe on a rear side of the vehicle body is fastened and fixed to each rear side frame 20. Note that the vehicle 1 is a rear wheel drive or a four wheel drive, and a motor 40 that is a high voltage component applies a driving force to rear wheels 4R and 4L. In other words, the vehicle 1 is an electric (electric-powered) vehicle (EV) using the motor 40 as a drive source.

Note that the suspension cross member 30 is a skeletal frame that supports the motor 40. In other words, the suspension cross member 30 constitutes a motor support frame.

The motor 40 is supported on the suspension cross member 30 with three motor mounts 42 and 43. The three motor mounts 42 and 43 control shake of the vehicle body and also absorb vibration, impact, and the like.

A pair of the motor mounts 42 support the motor 40 on a front side of the vehicle body. Each motor mount 42 as a front mount is provided on a front cross member 31 of the suspension cross member 30. The motor mounts 42 are separately fastened and fixed to left and right side portions of the motor 40 on the front side and the front cross member 31 with bolts as fastening members (not illustrated).

The one motor mount 43 as a rear mount supports the motor 40 on a rear side of the vehicle body. The motor mount 43 is fixedly provided at substantially a center of a rear cross member 32 of the suspension cross member 30. The motor mount 43 is fastened and fixed to a rear portion of the motor 40 and the rear cross member 32 with bolts as fastening members (not illustrated).

In other words, the motor 40 is put in a supported state via a total of the three motor mounts 42 and 43, where two on the side portions on the front side and one on the rear portion on the rear side, and is mounted on the suspension cross member 30 on the rear side.

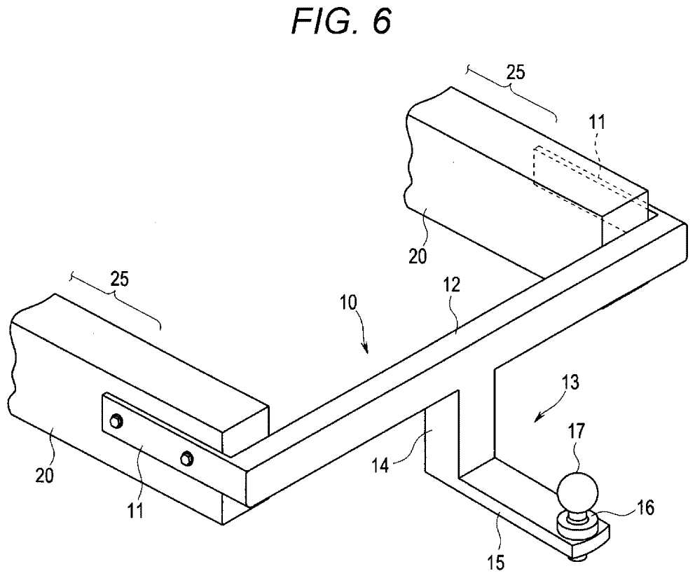

As illustrated in FIG. 6, the trailer hitch 10 includes a pair of hitch brackets 11 each fastened and fixed to a side surface of the rear side frame 20 on a vehicle width outer side with bolts or the like. The hitch brackets 11 are each disposed along a longitudinal direction of the rear side frames 20.

Each hitch bracket 11 constitutes a fixing member of the trailer hitch 10. Each hitch bracket 11 is formed in a plate shape or a cylindrical shape having a rectangular cross section. A cross member 12 is connected between the hitch brackets 11.

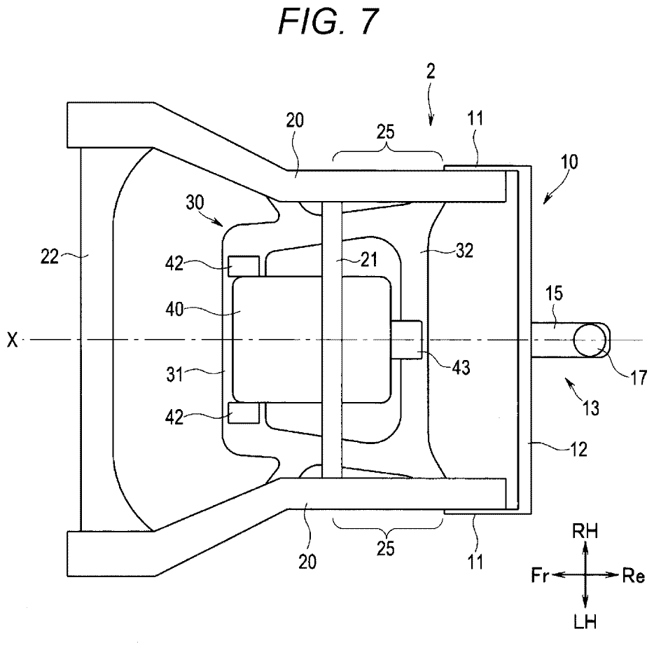

A hitch ball supporter 13 is fixedly provided at a center of the cross member 12 in a width direction. In other words, the hitch ball supporter 13 is provided at a substantially central position (a region parallel, in an up-down direction, to an axis X, which is a center axis of the vehicle 1 in the front-rear direction, illustrated in FIG. 7) of the cross member 12 attached to the vehicle rear body, in the vehicle width direction.

The hitch ball supporter 13 includes a stay 14, a hitch arm 15, and a hitch ball support shaft 16 that supports a hitch ball 17. The stay 14 projects from a center of the cross member 12 and extends downward. The hitch arm 15 protrudes rearward from a bottom portion of the stay 14.

The hitch ball support shaft 16 is erected on a rear end portion of the hitch arm 15. Note that the hitch ball 17 is provided on an upper portion of the hitch ball support shaft 16. The hitch ball supporter 13 is installed such that the hitch arm 15, the hitch ball support shaft 16, and the hitch ball 17 protrude from the vehicle rear body.

Note that, in rear end parts of the rear side frames 20, energy absorption (EA) crush zones 25 illustrated in FIG. 7 are set in a predetermined range in a parallel direction along the axis X that is a center axis of the vehicle 1 in the front-rear direction.

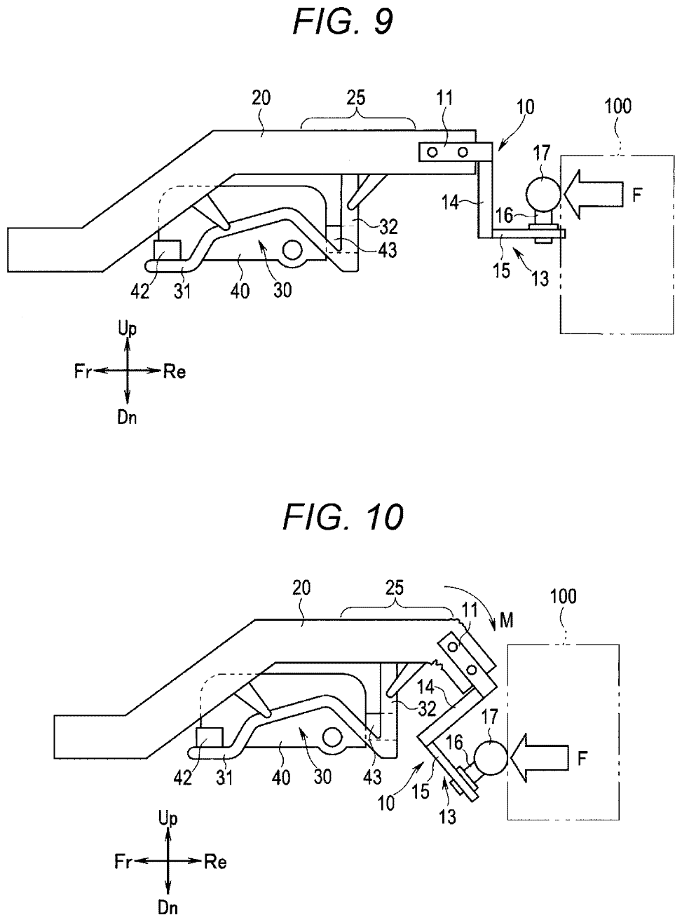

The EA crush zone 25 is a region that absorbs collision energy by crushing (causing buckling deformation multiple times) in an axial direction when being given a collision load F (see FIGS. 9 to 12) from a collision body 100 at a collision from behind.

Note that, for example, when the rear side frame 20 is directly processed to form the EA crush zone 25, a bellows (not illustrated) or the like is formed in a predetermined range from a rear end side to the front. In this bellows or the like, unevenness serving as a starting point of buckling is formed. The unevenness is formed by a bead or the like.

In the trailer hitch 10 fastened and fixed to the rear side frames 20, the hitch ball supporter 13 is disposed in a region in the up-down direction that is parallel to the axis X passing through substantially a center in the vehicle width direction and divides the left and right of the vehicle body. In other words, the stay 14, the hitch arm 15, the hitch ball support shaft 16, and the hitch ball 17 are provided in a region in the up-down direction parallel to the axis X.

The motor mount 43 on the rear side of the vehicle body that supports the motor 40 is provided in a region in the up-down direction parallel to the axis X passing through substantially a center of the suspension cross member 30 in the vehicle width direction.

In other words, the hitch ball supporter 13 and the motor mount 43 on the rear side of the vehicle body are provided in an up-down (vertical) plane orthogonal to a left-right (horizontal) plane passing through the axis X located substantially the center in the vehicle width direction.

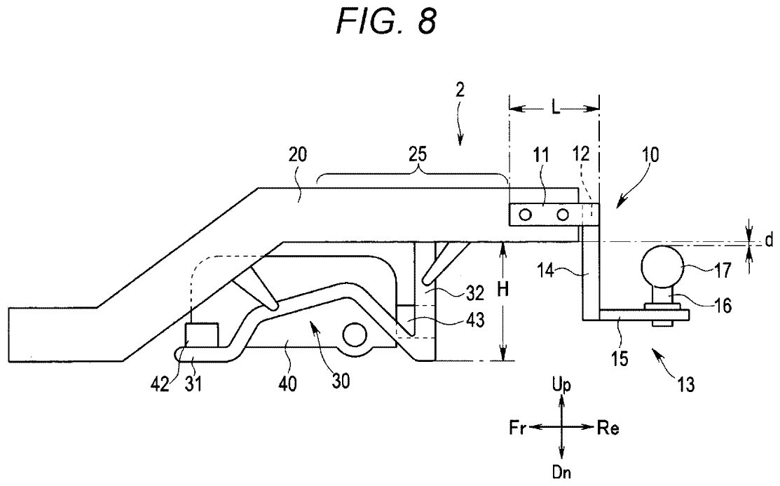

As illustrated in FIG. 8, the trailer hitch 10 is set at a position where an upper end of the hitch ball 17 is separated downward by a predetermined distance (range) d from a lower end of each rear side frame 20. In other words, the hitch ball 17 is offset downward from each rear side frame 20 by a predetermined distance (range) d.

In the trailer hitch 10, a predetermined length L of each hitch bracket 11 is set to be shorter than a predetermined height H from a lower end of the rear side frame 20 to a lower end of the suspension cross member 30 (L<H).

In the suspension cross member 30, an upper end portion of the front cross member 31 that supports the motor 40 on the front side of the vehicle body is disposed below a lower end portion of the motor 40. In different terms, the motor 40 is offset upward with respect to the front cross member 31 of the suspension cross member 30.

In other words, the motor 40 is placed on the front cross member 31 or at a position above the front cross member 31 and is fixed and supported by the suspension cross member 30 via the three motor mounts 42 and 43.

In this state, two side parts of the motor 40 on the front side are supported by the pair of motor mounts 42, and a lower central part of a rear portion of the motor 40 is supported by one motor mount 43, whereby the motor 40 is fixed to the suspension cross member 30.

Note that each motor mount 42 supporting the front side of the motor 40 is fixed to the front cross member 31 of the suspension cross member 30 and the motor 40 with bolts that are fastening fixing members (not illustrated). Each bolt for fixing the motor mount 42 to the front cross member 31 and the motor 40 is set to have predetermined strength adapted to break at a collision to the vehicle 1 from behind.

The motor mount 43 supporting the rear portion of the motor 40 is also fixed to the rear cross member 32 and the motor 40 with bolts that are fastening fixing members (not illustrated). Each bolt for fixing the motor mount 43 to the rear cross member 32 and the motor 40 is set to have predetermined strength adapted not to break even at a collision to the vehicle 1 from behind.

The trailer hitch 10, each rear side frame 20, and the suspension cross member 30 as a subframe supporting the motor 40 described above constitute a vehicle rear body structure 2 in the vehicle 1. Note that, the trailer hitch 10 is set to have predetermined rigidity adapted such that each hitch bracket 11, the cross member 12, and the hitch ball supporter 13 do not crack at a collision to the vehicle 1 from behind.

Next, behavior when the vehicle 1 including the vehicle rear body structure 2 is collided from behind will be described. As described above, in the vehicle 1 including the trailer hitch 10 of the present embodiment, the rear portion of the hitch arm 15 of the hitch ball supporter 13 protrudes from the center in the vehicle width direction of the vehicle rear body. Additionally, the hitch ball 17 is erected on a rear end of the hitch arm 15 with the hitch ball support shaft 16.

The hitch arm 15 is offset downward with respect to each hitch bracket 11 with which the trailer hitch 10 is fixedly provided in the two rear side frames 20. Then, the hitch ball 17 erected on the hitch arm 15 with the hitch ball support shaft 16 is offset downward from the lower end of each rear side frame 20 by the predetermined distance d.

Therefore, in the trailer hitch 10, when the collision load F is applied to the hitch ball 17 from the collision body 100 such as another vehicle or a collision test barrier from the rear, stress acts on the hitch ball 17 obliquely downward toward the front side of the vehicle body, as illustrated in FIG. 9. Note that, in the trailer hitch 10, a force that causes some swing obliquely downward toward the front side of the vehicle body is also applied to the rear end side of the hitch arm 15.

At this time, the trailer hitch 10 generates a rotational moment M about front end portions of the hitch brackets 11 each fastened and fixed to one of the rear side frames 20. Note that the trailer hitch 10 has predetermined rigidity enough not to deform even when given a collision load that crushes the EA crush zone 25 of each rear side frame 20.

Each hitch bracket 11 is set to have strength adapted not to crack at a collision. As a result, in an initial stage of the collision from behind by the collision body 100, the vehicle 1 generates a load of the rotational moment M in a clockwise direction in the trailer hitch 10, as illustrated in FIG. 10.

Then, in the EA crush zones 25 provided in each rear side frame 20, a tensile load toward the rear is generated in an upper portion and a compressive load toward the front is generated in a lower portion by the rotational moment M produced in the trailer hitch 10 with the front end portion of each hitch bracket 11 as a fulcrum.

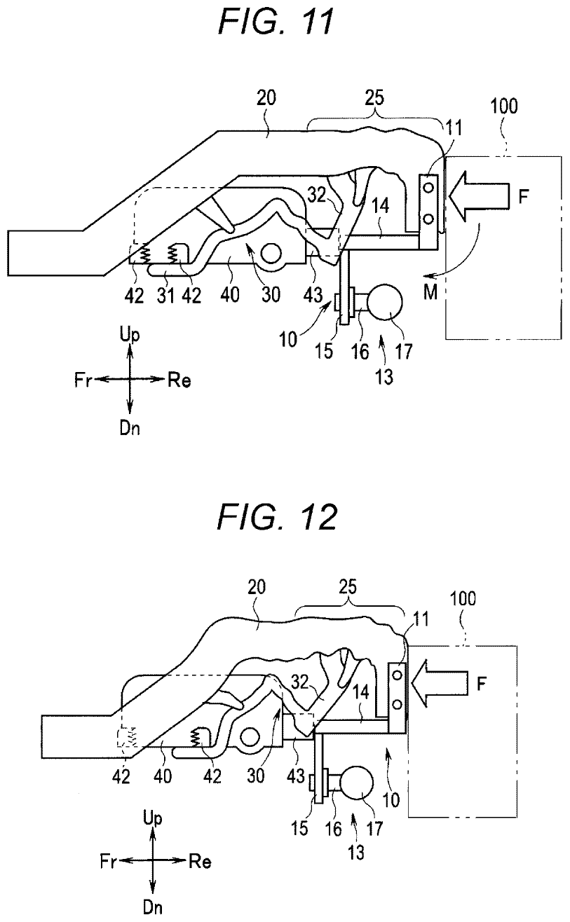

At this time, in the vehicle 1, the trailer hitch 10 continues to be given the load of the rotational moment M in the clockwise direction in a middle stage of the collision from behind by the collision body 100, as illustrated in FIG. 11.

Therefore, when the collision load F is further applied from the collision body 100, the trailer hitch 10 is rotated downward obliquely toward the front side of the vehicle body at approximately 90° by the rotational moment M. In other words, since the trailer hitch 10 is set to have predetermined rigidity adapted not to crack at a collision from behind, the trailer hitch 10 rotates approximately 90° clockwise without being substantially deformed.

At this time, the collision body 100 pushes the trailer hitch 10 toward the front side of the vehicle body while crushing the rear side frames 20 each in contact with a part where one of the hitch brackets 11 is provided. This causes each of the rear side frames 20 to bend and deform so as to be twisted sharply.

As described above, in the vehicle 1, a rear end upper portion as the EA crush zone 25 of each rear side frame 20 is formed bent, and the collision energy is absorbed by each rear side frame 20 when the lower portion is crushed.

The trailer hitch 10 is pushed and moved by the collision body 100 toward the front of the vehicle body as the EA crush zone 25 of each rear side frame 20 is crushed. At this time, in the trailer hitch 10, since the predetermined length L of each hitch bracket 11 is set to be shorter than the predetermined height H from each rear side frame 20 to the suspension cross member 30 (L<H), the hitch ball supporter 13 collides with the motor mount 43 fastened and fixed to the rear cross member 32 of the suspension cross member 30.

In the trailer hitch 10, since the motor mount 43 on the rear side of the vehicle body is positioned in an up-down (vertical) plane passing through the axis X at substantially the center in the vehicle width direction, the hitch ball supporter 13 rotated clockwise by approximately 90° regularly collides with the motor mount 43.

Note that, in the hitch ball supporter 13, a bottom surface of the hitch arm 15 at the lower end of the stay 14 collides with the motor mount 43. At that time, the motor mount 43 is pushed and moved by the hitch ball supporter 13 toward the front of the vehicle body.

Therefore, in the vehicle 1, the suspension cross member 30 to which the motor mount 43 is fastened and fixed is deformed as the EA crush zone 25 of each rear side frame 20 is crushed and absorbs the collision energy from the collision body 100.

The motor 40 placed on the suspension cross member 30 is pushed out and moved toward the front of the vehicle body as the motor mount 43 moves toward the front of the vehicle body. At this time, the pair of motor mounts 42 provided on the front cross member 31 of the suspension cross member 30 and supporting the front side of the motor 40 are broken. Besides, the bolts (not illustrated) for fastening and fixing the front cross member 31 and the motor 40 to each motor mount 42 are also broken at a collision to the vehicle 1 from behind.

This causes the motor 40 to be pushed out and moved toward the front of the vehicle body by the hitch ball supporter 13 of the trailer hitch 10 via the motor mount 43. At this time, the motor 40 moves so as to slide on the front cross member 31 toward the front side of the vehicle body.

As illustrated in FIG. 12, in a late stage of the collision from behind, the vehicle 1 can end the collision in a short stroke (span) with the deformation of the suspension cross member 30 as well as the absorption of the collision energy by each rear side frame 20.

As described above, in the vehicle rear body structure 2 of the vehicle 1 of the present embodiment, the position of the hitch ball 17 of the trailer hitch 10 fixedly provided in each rear side frame 20 is set to be lower than the lower end of each rear side frame 20 by the predetermined distance (range) d.

This sets the trailer hitch 10 such that the load of the rotational moment M in the clockwise direction, which is toward the front lower side of the vehicle body, is generated when the collision load F at a collision from behind is applied to the hitch ball 17 from the collision body 100. The trailer hitch 10 is set to have predetermined rigidity adapted not to crack at a collision from behind and is bent and deformed such that each rear side frame 20 is sharply twisted downward.

Besides this, in the trailer hitch 10, the predetermined length L of each hitch bracket 11 is set to be shorter than the predetermined height H from the lower end of each rear side frame 20 to the lower end of the suspension cross member 30 (L<H). This ensures that the hitch ball supporter 13 in the trailer hitch 10 collides with the motor mount 43 fixedly provided in the rear cross member 32 of the suspension cross member 30.

Then, the motor 40 is pushed out and moved toward the front of the vehicle body via the motor mount 43 supporting the rear, by the trailer hitch 10 moving toward the front of the vehicle body as each rear side frame 20 is crushed. Note that, when the motor 40 is pushed out toward the front of the vehicle body, the pair of motor mounts 42 supporting the front side and the bolts are broken.

Furthermore, in the vehicle rear body structure 2 of the vehicle 1, since the suspension cross member 30 is deformed in addition to the crush and deformation of each rear side frame 20 in a collision from behind, the collision energy may be absorbed in a short span.

As described above, the vehicle rear body structure 2 of the vehicle 1 absorbs the collision energy at a collision from behind by the collision body 100 in a short stroke (span) in an electric (electric-powered) vehicle (EV) driven by rear wheels.

Then, even when the motor 40 as a high voltage component, which is a relatively heavy and robust drive source unit, is mounted on the suspension cross member 30 between the rear side frames 20, the vehicle rear body structure 2 of the vehicle 1 moves the motor 40 so as to escape toward the front of the vehicle body.

This may allow the vehicle rear body structure 2 of the vehicle 1 to effectively protect the motor 40 as a high voltage component without damaging the motor 40.

Since the vehicle rear body structure 2 of the vehicle 1 may absorb the collision energy in a short span at a collision from behind, the vehicle rear body structure 2 may also be applied to a small-bodied vehicle having a short rear overhang.

Therefore, by adopting the vehicle rear body structure 2, the small-bodied vehicle 1 may be equipped with the trailer hitch 10 even if the vehicle 1 is an electric (electric-powered) vehicle (EV) driven by the rear wheels 4R and 4L.

As described above, the vehicle rear body structure 2 of the vehicle 1 of the present embodiment has a configuration that allows a small-bodied electric (electric-powered) vehicle (EV) including the trailer hitch 10 to absorb adequate collision energy at a collision from behind.

The vehicle rear body structure 2 of the vehicle 1 according to the disclosure is a technique applicable to various electric (electric-powered) vehicles (EVs) such as a battery electric vehicle (BEV), a hybrid electric vehicle (HEV), a plug-in hybrid electric vehicle (PHEV), and a fuel cell electric vehicle (FCEV) having a configuration in which a drive source that is the motor 40 as a high voltage component is provided on the suspension cross member 30 described herein, which is a subframe on the rear side.

The aspects of the disclosure described in the above embodiments are not limited to these modes, and other various modifications may be made in the implementation stage without departing from the gist of the disclosure. Furthermore, the above-described modes each include aspects of the disclosure in various stages, and various aspects of the disclosure may be extracted by appropriately combining disclosed constituent elements.

For example, when the problem described herein can be solved and the effect described herein can be obtained even if some constituent elements are deleted from all the constituent elements illustrated in each mode, such a configuration obtained by deleting the constituent elements may be extracted as an aspect of the disclosure.

1. A vehicle rear body structure of a vehicle, the vehicle rear body structure comprising:
a pair of rear side frames extending along a front-rear direction in a rear part of a vehicle body;
a trailer hitch fixedly provided in the rear side frames;
a subframe provided between the rear side frames;
a high voltage component placed on the subframe and configured to drive a rear wheel of the vehicle; and
mounts supporting the high voltage component on the subframe, wherein
the trailer hitch comprises:
a pair of brackets fixed to the rear side frames respectively and having a length in the front-rear direction set to be shorter than a height in an up-down direction of the vehicle body from a lower end of the rear side frames to a lower end of the subframe;
a cross member provided between the pair of brackets;
a stay projecting from a center in a vehicle width direction of the cross member and extending downward;
an arm projecting from a bottom portion of the stay and extending rearward;
a support shaft erecting on a rear end portion of the arm; and
a hitch ball provided on an upper portion of the support shaft and provided below the pair of rear side frames,
the mounts comprise:
a pair of front mounts supporting two side portions on a front side of the high voltage component; and
a rear mount supporting a rear portion of the high voltage component at the center in the vehicle width direction, and
the vehicle rear body structure of the vehicle is configured such that a rotational moment is generated on a downward side where the trailer hitch being given a collision load from a collision body collides with the rear mount at a collision from behind.

2. The vehicle rear body structure of the vehicle according to claim 1, wherein
in the subframe, an upper end portion of a front cross member is provided below a lower end portion of the high voltage component, and
the pair of the mounts supporting the two side portions of the high voltage component are fixedly provided in the front cross member.

3. The vehicle rear body structure of the vehicle according to claim 2, wherein a fastening member fastening the pair of the front mounts to the high voltage component and the front cross member has predetermined strength adapted to break when the trailer hitch rotating at the collision from behind collides with the rear mount and the high voltage component is pushed out and moved toward the front of the vehicle body.

4. The vehicle rear body structure of the vehicle according to claim 1, wherein the trailer hitch has predetermined rigidity adapted not to deform at the collision from behind.

5. The vehicle rear body structure of the vehicle according to claim 2, wherein the trailer hitch has predetermined rigidity adapted not to deform at the collision from behind.

6. The vehicle rear body structure of the vehicle according to claim 3, wherein the trailer hitch has predetermined rigidity adapted not to deform at the collision from behind.

7. The vehicle rear body structure of the vehicle according to claim 4, wherein the high voltage component is a motor configured to drive the rear wheel.

8. The vehicle rear body structure of the vehicle according to claim 5, wherein the high voltage component is a motor configured to drive the rear wheel.

9. The vehicle rear body structure of the vehicle according to claim 6, wherein the high voltage component is a motor configured to drive the rear wheel.
